(19) United States
(12) Patent Application Publication
(10) Pub. No.: US 2024/0111548 A1
(43) Pub. Date: Apr. 4, 2024

(54) CLOUD SERVER AND METHOD FOR CONVERTING SOFTWARE IMAGE OF ROBOT IN CLOUD SERVER

(71) Applicant: LG ELECTRONICS INC., Seoul (KR)

(72) Inventors: Sewan GU, Seoul (KR); Seungmin BAEK, Seoul (KR); Hyunseok YANG, Seoul (KR); Youngjae KIM, Seoul (KR); Sungkyu KANG, Seoul (KR)

(73) Assignee: LG ELECTRONICS INC., Seoul (KR)

(21) Appl. No.: 18/553,963

(22) PCT Filed: Apr. 8, 2021
(86) PCT No.: PCT/KR2021/004401

§ 371 Date: Oct. 4, 2023

(30) Foreign Application Priority Data
Apr. 7, 2021 (KR) 10-2021-0045241

(51) Int. Cl. G06F 9/445; B25J 9/00; B25J 9/16; G06F 8/65

(52) U.S. Cl. CPC G06F 9/445; B25J 9/0084; B25J 9/1656; G06F 8/65

(57) ABSTRACT

The present disclosure relates to a cloud server, comprising a communication unit transmitting and receiving data to and from at least one robot and an external device; and a control unit which receives a first signal including operating system information of a first robot, hardware information of the first robot, and software information of the first robot from a first robot among the at least one robot; if no software image corresponding to the first signal is present, extracts the operating system information of the first robot, the hardware information of the first robot, and the software information of the first robot from the first signal; generates a software image based on the extracted operating system information of the first robot, the extracted hardware information of the first robot, and the extracted software information of the first robot; and transmits the generated software image to the first robot.

### TECHNICAL FIELD

The present disclosure relates to a cloud server and a method of converting a software image of a robot in the cloud server.

In more detail, the present disclosure relates to a cloud server and a method of converting a software image of a robot in the cloud server, in which the software image is transmitted to a robot based on a signal received by the cloud server from the robot.

### BACKGROUND

A typical robot industry has mainly focused on industrial robots, but the number of robots performing various functions has increased due to recent developments in robot technology and public interest in the use of robots. However, robots have different robot capabilities, such as whether they are robots with arms, or robots with legs or wheels and no monitor, and operating systems used by each robot and the characteristics of hardware provided in each robot are different.

Nevertheless, unlike other computing industries, the cloud robot industry does not have a common interface or communication standard between robots and uses various operating systems.

In particular, the robot may selectively use various input/output boards and use one or more processors, and various operating systems such as Linux, Windows, real-time operating system, and embedded Linux, and middleware such as ROS, OPRoS, OpenRTM, and OROCOS may be operated on a processor board.

Therefore, even if applications and robot contents required or executable by respective robots have the same function, the applications and robot contents are inevitably different depending on a processor board, an operating system, middleware, robot capabilities, or the like.

Accordingly, a cloud robot system needs convert software such that robots using different operating systems (OS), different hardware, and different software are compatible.

### DISCLOSURE

### Technical Problem

An object of the present disclosure is to resolve the aforementioned problem and other problems.

An object of the present disclosure is to provide specific software image optimized for each robot in consideration of a robot operating system (OS), hardware, and software by a cloud server and to update and manage information.

In more detail, an object of the present disclosure is to provide a robot system and a control method, which manage robots in an integrated manner regardless of whether different OS and hardware are installed in separate robots.

### Technical Solution

According to an aspect of the present disclosure, a cloud server connected to at least one robot includes a communicator configured to transmit and receive data to and from the at least one robot and an external device, and a controller, wherein the controller receives a first signal including operating system (OS) information of a first robot, hardware information of the first robot, and software information of the first robot, from the first robot among the at least one robot, based on presence of a software image related to the first signal, the controller transmits the software image to the first robot, based on absence of the software image related to the first signal, the controller extracts the OS information of the first robot, the hardware information of the first robot, and the software information of the first robot, from the first signal, the controller creates a software image based on the extracted OS information of the first robot, the extracted hardware information of the first robot, and the extracted software information of the first robot, and the controller transmits the created software image to the first robot.

According to an aspect of the present disclosure, the cloud server further includes a memory configured to store information related to the at least one robot, wherein, based on presence of the software image related to the first signal in the memory, the stored software image is transmitted to the first robot.

According to an aspect of the present disclosure, the controller creates a docker file from a docker file template based on the extracted OS information of the first robot, the extracted hardware information of the first robot, and the extracted software information of the first robot, creates a software image based on the created docker file, and transmits the created software image to the first robot.

According to an aspect of the present disclosure, the controller includes a robot profile register and a robot software converter, the robot software converter requests a profile of the first robot from the robot profile register, and the robot profile register transmits the profile to the robot software converter.

According to an aspect of the present disclosure, the robot software converter creates the software image based on the received profile, and the created software image is transmitted to the first robot.

According to an aspect of the present disclosure, based on that the software image related to the first signal is present in the memory but does not satisfy a specification condition, the controller converts the software image to be suitable for a specification and transmits the converted software image to the first robot.

According to an aspect of the present disclosure, based on being connected to a second robot having a different capability from the first robot, the controller receives OS information of the second robot, hardware information of the second robot, and software information of the second robot, from the communicator, converts work information of the second robot based on the received OS information of the second robot, the received hardware information, and the received software information of the second robot, and transmits the converted work information to the second robot.

According to an aspect of the present disclosure, the controller converts the work information to assign a priority to a robot located on a specific path.

According to an aspect of the present disclosure, based on being connected to a third robot having a different capability from the first robot, the controller receives OS information of the third robot, hardware information of the third robot, and software information of the third robot, from the communicator, based on updating of a first function of the first robot, the controller updates the first function of the third robot to be a same as the first robot based on the OS information of the third robot, the hardware information of the third robot, and the software information of the third robot, and the controller transmits a second signal including information related to the first function to the third robot.

According to an aspect of the present disclosure, a method of converting a software image of a robot in a cloud server connected to at least one robot includes receiving a first signal including operating system (OS) information of a first robot, hardware information of the first robot, and software information of the first robot, from the first robot among the at least one robot, based on presence of a software image related to the first signal, transmitting the software image to the first robot, based on absence of the software image related to the first signal, extracting the OS information of the first robot, the hardware information of the first robot, and the software information of the first robot, from the first signal, creating a software image based on the extracted OS information of the first robot, the extracted hardware information of the first robot, and the extracted software information of the first robot, and transmitting the created software image to the first robot.

### Advantageous Effects

The effects of a mobile terminal and a control method thereof according to the present disclosure are explained as follows.

According to at least one of embodiments of the present disclosure, a cloud server may determine the operating system (OS), hardware, and software of a robot to advantageously update and manage software of the robot to be suitable for separate robots.

According to at least one of embodiments of the present disclosure, the cloud server may determine the OS, hardware, and software of the robot to advantageously convert a software image when the software image does not meet conditions.

According to at least one of embodiments of the present disclosure, the cloud server may advantageously convert work information of the robot based on the OS, hardware, and software of the robot.

According to at least one of embodiments of the present disclosure, when the cloud server updates a function of one robot, a function of another robot may be advantageously updated in the same way.

According to at least one of embodiments of the present disclosure, it may be possible to advantageously manage the specifications of robots with different OSs and hardware in a standardized format.

Additional scope of applicability of the present disclosure will become apparent from the detailed description below. However, various changes and modifications within the spirit and scope of the present disclosure may be clearly understood by those skilled in the art, and thus the detailed description and specific embodiments such as embodiments of the present disclosure need to be understood as being given only as examples.

### BRIEF DESCRIPTION OF THE DRAWINGS

FIG. 1 is a diagram for explaining an example in which a cloud server communicates with a robot, according to an embodiment of the present disclosure.

FIG. 2 is a diagram for explaining an example in which a robot software converter of a cloud server creates a software image, according to an embodiment of the present disclosure.

FIG. 3 is a diagram for explaining another example in which a cloud server communicates with a robot, according to an embodiment of the present disclosure.

FIG. 4 is a diagram for explaining another example in which a robot software converter of a cloud server creates a software image, according to an embodiment of the present disclosure.

FIG. 5 is a flowchart for explaining an example in which a docker file is created using a profile template of a robot, used in a cloud server, according to an embodiment of the present disclosure.

FIG. 6 is a diagram for explaining an example in which a cloud server manages work information of a robot, according to an embodiment of the present disclosure.

FIG. 7 is a diagram for explaining an example in which a cloud server updates a function of a robot, according to an embodiment of the present disclosure.

### BEST MODE

Reference will now be made in detail to embodiments of the present disclosure, examples of which are illustrated in the accompanying drawings. Wherever possible, the same reference numbers will be used throughout the drawings to refer to the same or like parts, and redundant description thereof will be omitted. As used herein, the suffixes “module” and “unit” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, are not construed as limiting the technical spirit disclosed in the present specification, and include all modifications, equivalents, and substitutions within the spirit and scope of the embodiments.

It will be understood that, although the terms first, second, third etc. may be used herein to describe various elements, these elements should not be limited by these terms. These terms are only used to distinguish one element from another element.

It will be understood that when an element is referred to as being “connected to” or “coupled to” another element, it may be directly on, connected or coupled to the other element or intervening elements may be present. In contrast, when an element is referred to as being “directly on,” “directly connected to” or “directly coupled to” another element, there are no intervening elements or layers present.

As used herein, the singular forms are intended to include the plural forms as well, unless the context clearly indicates otherwise.

It will be further understood that the terms “comprise”, “include” or “have” when used in this specification, specify the presence of stated features, integers, steps, operations, elements, components, or combinations thereof do not preclude the presence or addition of one or more other features, integers, steps, operations, elements, components, or combinations thereof.

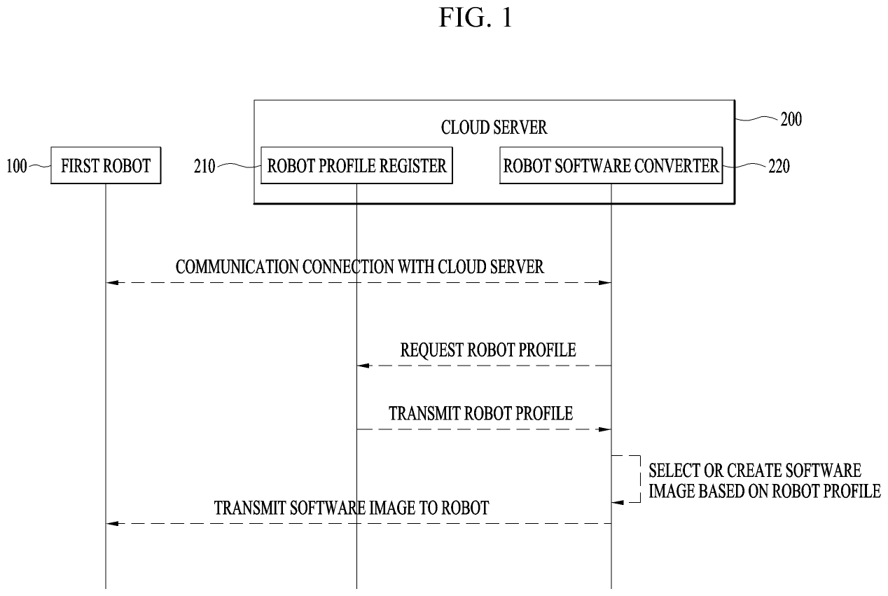

FIG. 1 is a diagram for explaining an example in which a cloud server communicates with a robot, according to an embodiment of the present disclosure.

Referring to FIG. 1, a cloud server 200 may be connected to at least one robot including a first robot 100. Hereinafter, an example in which the cloud server 200 is connected to the first robot 100 will be described. However, needless to say, the cloud server 200 may be simultaneously connected to a plurality of robots.

The cloud server 200 may include a communicator and a controller.

The communicator may connect the cloud server 200 to at least one robot and transfer data transmitted to and received from the robot to the cloud server 200.

According to an embodiment of the present disclosure, the communicator may receive a first signal including operating system (OS) information, hardware information, and software information of the connected first robot 100.

According to an embodiment of the present disclosure, when there is a software image corresponding to the first signal, the communicator may transmit the software image to the first robot 100.

As the controller receives the first signal through the communicator, the controller may determine whether there is the software image corresponding to the first signal.

According to an embodiment of the present disclosure, when there is the software image corresponding to the first signal, the controller may transmit the software image to the first robot 100.

According to another embodiment of the present disclosure, when there is no software image corresponding to the first signal, the controller may extract the OS information of the first robot 100, the hardware information of the first robot 100, and the software information of the first robot 100, from the first signal.

The controller may create the software image based the extracted OS information of the first robot, and the extracted hardware information of the first robot, and the software information of the first robot. Then, the controller may transmit the created software image to the first robot 100 through the communicator.

The controller may further include a robot profile register 210 and a robot software (SW) converter 220 to perform the aforementioned embodiment.

After the first robot 100 is connected to the cloud server 200, the robot software converter 220 may request a robot profile of the first robot 100 from the robot profile register 210. That is, the aforementioned first signal may include a robot profile request signal.

Here, the robot profile may correspond to a format that defines the specifications of hardware and software of a robot. The hardware may include hardware products such as a CPU/GPU, a RAM, a sensor, a camera, a motor, a microphone, and a speaker. The software may include an operating system (OS), middleware platform, driver, function, and the like. In addition, the format may be written in json, yaml, or the like and json and yaml may be converted to each other.

According to an embodiment of the present disclosure, at least one robot may communicate with a server (a RAP server or the cloud server in the present disclosure) that stores a robot profile. This will be described below in detail.

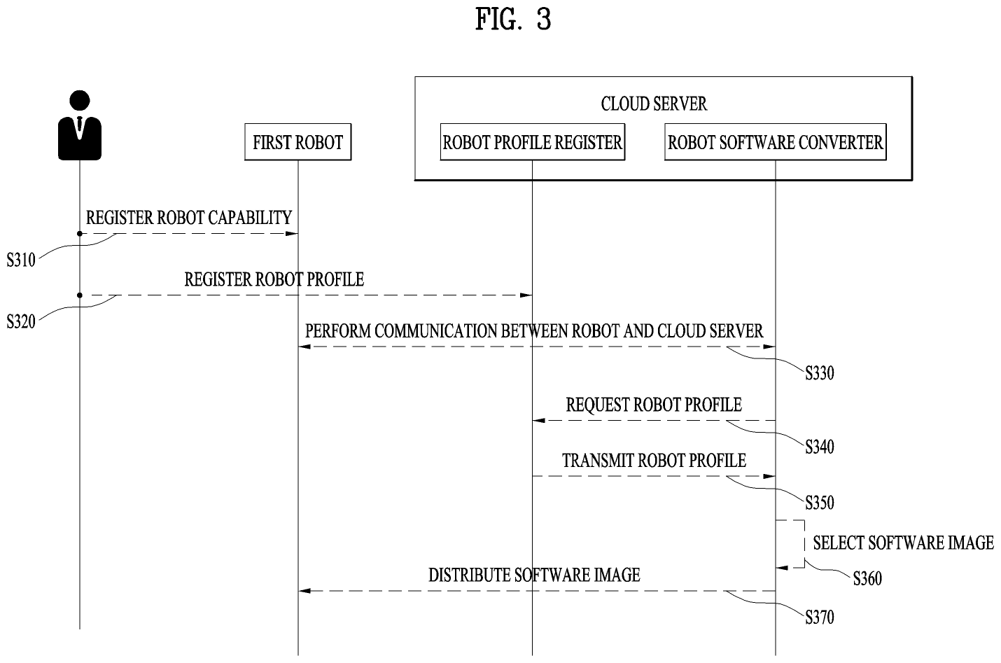

According to an embodiment of the present disclosure, the robot profile register 210 may pre-store the robot profile of the first robot 100. In this case, the robot profile register 210 may receive a server address RAProfile.site in which a profile of the first robot is stored, from the first robot 100. The robot profile register 210 may be configured with a separate UAProfile server. This will be described in detail with reference to FIG. 3.

Thus, the robot profile register 210 may transmit the robot profile of the first robot 100 to the robot software converter 220. Here, the robot profile of the first robot 100 may include the OS information, the hardware information, and the software information of the first robot 100.

The robot software converter 220 may select or create a software image based on the received robot profile. Here, the hardware configuration of the robot software converter 220 may be assumed to be a typical Linux server. The robot software converter 220 is assumed to be applicable to all robots.

In more detail, when there is a software image of the first robot 100, which corresponds to the received robot profile of the first robot 100, the software image may be selected.

In contrast, when there is no software image of the first robot 100, which corresponds to the received robot profile of the first robot 100, the software image may be created based on the received robot profile of the first robot 100.

That is, according to an embodiment of the present disclosure, the robot software converter 220 may search for functions required by the robot and select, convert, or create the functions.

Then, the robot software converter 220 may transmit the selected or created software image to the first robot 100.

Then, although not shown in the drawing, the cloud server may remotely deploy the first robot 100, and the first robot 100 may reboot to use a corresponding function.

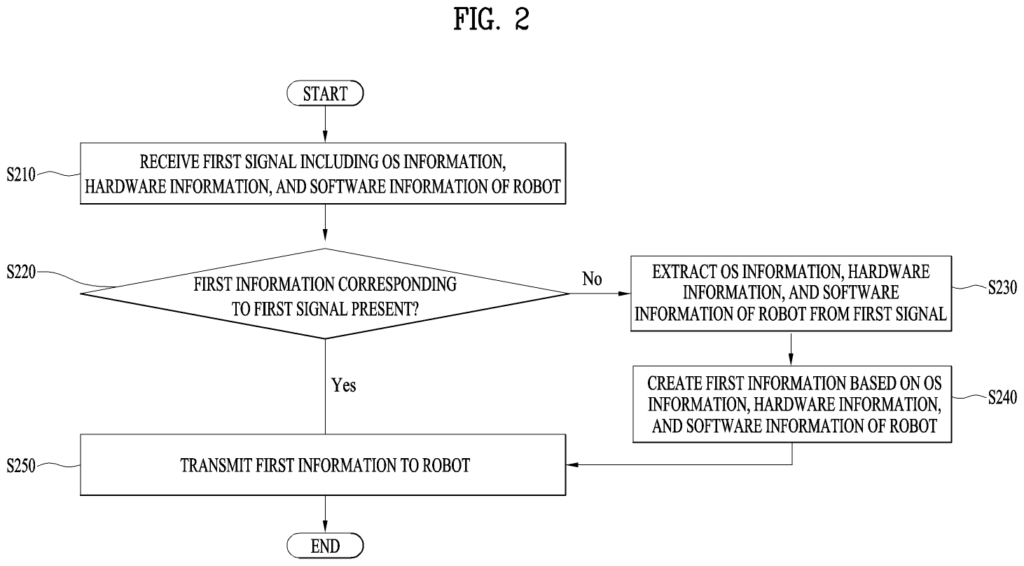

FIG. 2 is a diagram for explaining an example in which a robot software converter of a cloud server creates a software image, according to an embodiment of the present disclosure.

Referring to FIG. 2, in operation S210, the robot software converter may receive a first signal including robot OS information, hardware information, and software information, from a robot. Here, the first signal may include a robot profile.

In this case, a cloud server may store a server address RAProfile.site in which the robot profile from the robot is stored and receive a robot profile RAProfile.xml including the OS information, the hardware information, and the software information of the robot, from the server.

In operation S220, the robot software converter may determine whether there is first information corresponding to the first signal. Here, the first information may correspond to a software image of the robot.

When there is no first information, in operation S230, the robot software converter may extract the OS information, the hardware information, and the software information of the robot, from the first signal. That is, the robot software converter may extract the OS information, the hardware information, and the software information of the robot, from the robot profile.

In operation S240, the robot software converter may create the first information based on the extracted OS information, hardware information, and software information of the robot. Here, the first information may correspond to the software image of the robot. That is, the robot software converter may create the software image of the robot based on the extracted OS information, hardware information, and software information of the robot.

In this case, according to an embodiment of the present disclosure, the robot software converter may create the software image of the robot based on the capabilities of the robot that is currently wanted to be connected.

Then, the robot software converter may transmit the created software image to the robot according to operation S250.

When there is first information, the robot software converter may transmit the first information to the robot in operation S250. According to the aforementioned embodiment, needless to say, even if there is no first information, the created first information may be transmitted to the robot.

Although not shown in the drawing, the cloud server may be connected to a terminal including a display such as a touchscreen and may transmit a control signal to the terminal to output results of embodiments performed by the cloud server to the terminal through the display of the terminal. Thus, a user using the terminal may check and control the results of the embodiments performed by the cloud server through the display of the terminal.

FIG. 3 is a diagram for explaining another example in which a cloud server communicates with a robot, according to an embodiment of the present disclosure.

Compared with FIG. 1, FIG. 3 will be explained including a specific file transmitted and received by a cloud server, a user, and a robot.

Referring to FIG. 3, in operation S310, the user may register the capability if a robot in a website when the robot is released. For example, when the robot is released, a user that is a robot vendor may register the capability of the robot or a robot that is a purchaser of the robot may register the capability of the robot.

According to an embodiment of the present disclosure, the user may register a robot profile including OS information, hardware information, and software information of the robot, in a website. In this case, the registered robot profile may have a format of an xml file, a yaml file, or a json file.

In operation S320, the user may register the robot profile of the robot in the cloud server.

In more detail, the user may register the aforementioned robot profile of the robot in a robot profile register of the cloud server. In this case, the registered robot profile may also have a format of an xml file, a yaml file, or a json file. According to an embodiment of the present disclosure, the user may register a server address in which the profile of the robot is stored, in the cloud server. That is, the robot may inform the cloud server of the RAP server address that stores the robot profile RAProfile. Thus, the cloud server may access the RAP server and acquire hardware information and software information through the corresponding robot profile of the corresponding robot.

That is, specific product information about the robot, provided by a robot vendor, may be prestored in the cloud server or an external server. Here, the produce information of the robot may include all of the OS information, the hardware information, and the software information of the robot. The cloud server may recognize the hardware information of the robot with reference to an internal memory or an external server.

In operation S330, the cloud server and the robot may communicate with each other while connected. In particular, according to an embodiment of the present disclosure, the cloud server and the robot may respond to a state in which basic communication such as a message of 160 bytes or less is always possible.

According to an embodiment of the present disclosure, the robot may request software update from the cloud server. The cloud server may transfer the software update of the robot to the robot software converter.

Accordingly, in operation S340, the robot software converter may request a profile of the robot in the robot profile register. In this case, the robot software converter may request a profile for the capability of the robot.

In operation S350, the robot profile register may transmit the registered profile of the robot to the robot software converter based on the profile request for the robot capability. In this case, the robot profile register may transmit the registered profile of the capability of the robot, to the robot software converter.

In operation S360, the robot software converter may select an appropriate software image based one the received profile of the robot.

In this case, when there is no appropriate software image based on the profile of the robot, the robot software converter may create the appropriate software image.

When the appropriate software image is present in the cloud server or does not satisfy the specification condition, the robot software converter may convert the software image to suit the specifications.

According to an embodiment of the present disclosure, the received profile of the capability of the robot may be based when the robot software converter selects, creates, and converts the software image.

In more detail, the robot software converter may create a docker file using a docker file template based on the OS information, the hardware information, and the software information of the robot from the received profile of the robot. In addition, the robot software converter may create a software image based on the created docker file. The docker file will be described in detail with reference to the following drawings.

The robot software converter may transmit the selected or created software image to the robot. In this case, the software image may be a software image for an agent, an engine, and data.

In operation S370, the robot software converter may distribute the software image in the form of a docker file.

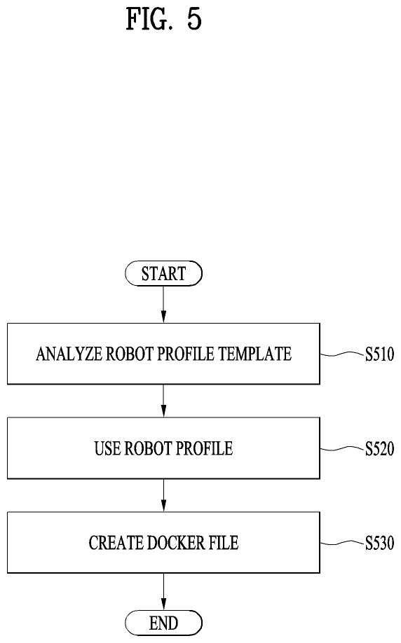

According to an embodiment of the present disclosure, the docker file may be created based on the OS information, the software information, and the hardware information of the robot and may create the software image based on the docker file. In detail, the robot software converter may select the same robot OS based on the robot OS information and create the docker file corresponding to the hardware information and the software information from the docker file template according to a build instruction used in the selected robot OS. That is, the feature is that a robot-specific software image is created based on the OS information, the hardware information, and the software information of the robot. This will be described in detail with reference to FIGS. 5 to 9.

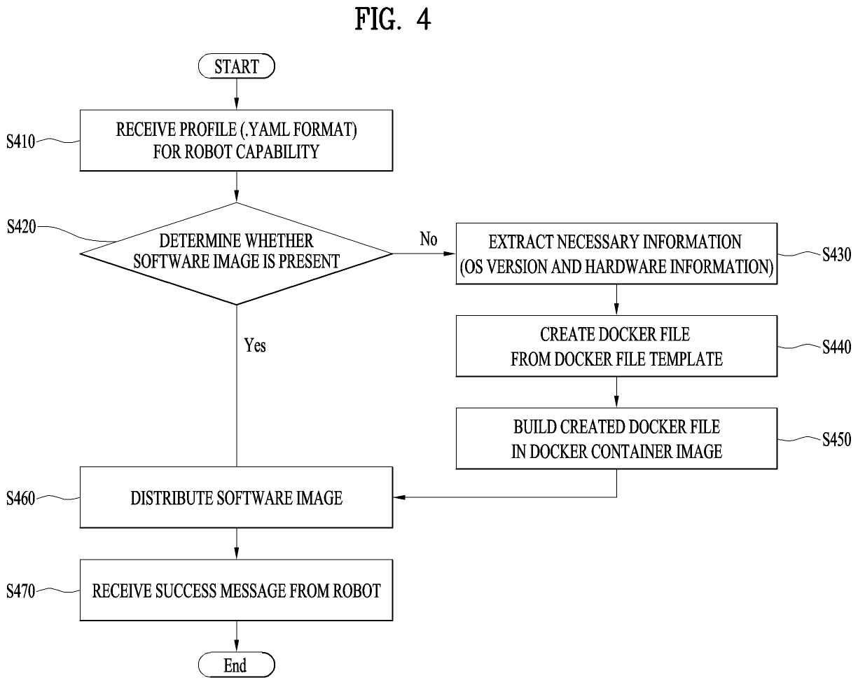

FIG. 4 is a diagram for explaining another example in which a robot software converter of a cloud server creates a software image, according to an embodiment of the present disclosure.

Compared with FIG. 2, FIG. 4 will be explained including a specific file from which the robot software converter of the cloud server creates the software image.

Referring to FIG. 4, in operation S410, the robot software converter may receive a profile of capability of a robot. Here, the profile of the capability of the robot may correspond to a format of a yaml file.

In operation S420, the robot software converter may determine whether there is an appropriate software image in a cloud server based on the profile of the capability of the robot. According to an embodiment of the present disclosure, the robot software converter may check whether there is a currently sought software image through an instruction “$ docker image Is”.

When there is no appropriate software image, in operation S430, the robot software converter may extract necessary information, that is, OS information, hardware information, and software information of the robot, from the received profile.

Here, main boards of the robot may have different OSs. For example, the main boards of the robot may have different versions of OS, such as Linux 18.03 (Bionic) or 20.04 (Foxy). In addition to the main boards of the robot, uiBoard and controlBoard may also have different OSs.

The hardware information of the robot may include CPU information, motor information, battery specification information, and connectivity information. In this case, the hardware information of the robot may actually be used to create a software image by selectively compiling an application.

In operation S440, the robot software converter may create a docker file corresponding to the robot using the information extracted from the aforementioned profile and a docker file template. In this case, the robot software converter may create a docker file corresponding to the current robot through an instruction “$ docker build-t-mainboard-version-new-2.0-f./docker file”.

In operation S450, the robot software converter may build the created docker file in a docker-container image.

Then, the robot software converter may the built docker-container image to the robot according to operation S460.

When there is a software image, in operation S460, the robot software converter may transmit (distribute) the software image to the robot. Needless to say, according to the aforementioned embodiment, even if there is no software image, the created software image may be transmitted to the robot.

In operation S470, the cloud server may receive a message “succeed” from the robot through the communicator.

FIG. 5 is a flowchart for explaining an example in which a docker file is created using a profile template of a robot, used in a cloud server, according to an embodiment of the present disclosure.

In operation S510, the cloud server may analyze the profile template of the robot, used to create the docker file of the robot. For example, the profile template of the robot may have examples shown in [Table 1] and [Table 2] below.

TABLE 1

```
robotCategory : delivery/foodAndbeverage
robotSite : restaurant
robotID : lgeDeliveryFnB/ID000001
robotHardwareInfo :
vendor:  LGE
motor:
- vendor :
    rpm:
    method :
spec:
- wheelnumber :
        diameter :
  battery :
- vendor :
    spec :
  controlBoard :
- vendor :
    spec :
  mainBoard :
- vendor :
    spec :
cpu:  TX2
memory: 2GB
  uiBoard :
- vendor :
    spec :
```

[Table 1] shows a profile template of a robot, used in a cloud server, according to an embodiment of the present disclosure.

According to an embodiment of the present disclosure, the cloud server may use the profile template to create a docker file, and the profile template of the robot may have various templates, and thus an example of [Table 1] may be provided. Needless to say, the cloud server may use other profile templates as well as the profile template of [Table 1].

Referring to [Table 1], the robot profile template may include a robot category, a robot site, a robot ID, and robot hardware information.

In more detail, the robot category may indicate a type of robot. For example, the robot category may indicate whether the type of robot is a delivery robot or a food and beverage production robot.

The robot site may indicate where the robot is used. For example, the robot site may indicate whether a place in which the robot is used is a restaurant.

The robot ID may indicate a unique identification number of the robot. For example, the robot ID may be represented by “lgeDeliveryFnB/ID000001”.

The robot hardware information may include vendor information, motor information, battery information, control board information, main board information, and ui board information of the robot.

The motor information may include vendor information, rpm information, method information, and specification information of the motor, and the specification information may further include wheel number and diameter information.

Likewise, the battery information, the control board information, the main board information, and the ui board information may include each vendor information and specification information.

```
TABLE 2
ARG FROM_IMAGE=Linux:bionic
FROM $FROM_IMAGE
# setup timezone
RUN echo ‘Etc/UTC’ > /etc/timezone && \
  ln -s /usr/share/zoneinfo/Etc/UTC /etc/localtime && \
  apt-get update && apt-get install -q -y tzdata && rm
  -rf/var/lib/apt/lists/*
# install packages
RUN apt-get update && apt-get install -q -y \
  hash-completion \
  dirmngr \
  gnupg2 \
  lsb-release \
  python3-pip \
&& rm --rf/var/lib/apt/lists/*
# install ROS2 Platform
RUN apt-get install ros-dasing-ros-base
## LGE Package install (download using LGE internal repository)
## Delete old version, add new version (example)
RUN rm --rf/install/navigation1
COPY navigation2/install/
RUN rm --rf/install/intelligence1
COPY /intelligence2/install/
# build source with new package
RUN colcon \
  build \
  --cmake args \
    -DSECURITY=ON --no-warn-unused-cli \
  --symlink-install
# setup hashrc
RUN cp /etc/skel/hashrc~/
# setup entrypoint
COPY ./ros_entrypoint.sh /
ENTRYPOINT [“/ros_entrypoint.sh”]
CMD [“hash”]
```

[Table 2] shows another example of a docker file template used in a cloud server, according to an embodiment of the present disclosure.

With reference to [Table 2], one example of the docker file template used in the cloud server will be described. In this case, the docker file template in [Table 2] is explained using a docker file template applied to a robot operating system (ROS2) as an example, but may also be applied to other Os, needless to say.

According to an embodiment of the present disclosure, the docker file template may include information about time zone setup, package installation, platform installation, vendor package update, new package creation, and setup.

In more detail, according to an embodiment of the present disclosure, it may be possible to define an image to be built as “Linux:bionic” through an ARG instruction through the docker file template. According to an embodiment of the present disclosure, a container time of a docker may be configured through a RUN echo instruction. According to an embodiment of the present disclosure, a package may be managed through a RUN apt-get update/install instruction. According to an embodiment of the present disclosure, a ROS platform may be installed through a RUN apt-get install ros instruction. According to an embodiment of the present disclosure, an old version of the package may be deleted and a new version may be installed through a RUN rm-rf/install instruction. According to an embodiment of the present disclosure, a robot application may be built using colcon through a RUN colcon instruction. According to an embodiment of the present disclosure, bashrc (the most widely used shell in Linux) may be executed and an entrypoint may be configured.

According to an embodiment of the present disclosure, needless to say, not all of the instructions in the docker file template described above may be included and only some of the instructions may be used.

In operation S520, the cloud server may use a profile according to the robot capability. In other words, the cloud server may use a robot profile according to the robot capability to create a docker file, and for example, the profile for the docker file in [Table 3] below may be used.

TABLE 3

```
robotmechnicalInfo:
  Size:
    hight: 1000 ## unit: mm
    widht: 500
    depth: 450
  IMU:
    x: 250
    y: 200
    z: 200
  Lidar:
    x: 500
    y: 50
    z: 200
```

[Table 3] shows a profile for a docker file created by a cloud server according to an embodiment of the present disclosure.

[Table 3] shows a robot profile including hardware information of a robot. That is, [Table 3] may correspond to a robot profile received for the docker file created by the cloud server.

Referring to [Table 3], the robot profile may include the hardware information of the robot. In this case, the hardware information of the robot may include the overall size of the robot, imu hardware information, and lidar hardware information. That is, as in the above-described example, the robot profile according to an embodiment of the present disclosure may include hardware information about a sensor included in the robot.

In operation S530, the cloud server may create the docker file using the robot profile template and the robot profile. [Table 4] and [Table 5] below shows an example of the created docker file, and the cloud server may create the docker file using the aforementioned robot profile template and robot profile. Then, the cloud server may distribute software image using the created docker file and update an OS or software of the robot.

```
TABLE 4
FROM ubuntu:18.04
# setup timezone
RUN echo ‘Etc/UTC’ > /ext/timezone && \
  ln -s /usr/share/zoneinfo/Etc/UTX /ect/localtime &&
  apt-get update && apt-get install -q -y tzdata && rm -rf
  /var/lib/apt/lists/*
# install packages
RUN apt-get update && apt-get install -q -y \
  hash-completion \
  dirmngr \
  gnupg2 \
  lsb-release \
  python3-pip \
  && rm -fr /var/lib/apt/lists/*
# setup keys
RUN apt-key adv --keyserver hkp://keyserver.ubuntu.com:80 -- recv-keys
C1CF6E31E6BADE8868B172B4F42ED6FBAB17C654
# setup keys
RUN echo “deh http://packages.ros.org/ros2/ubuntu ‘lsb_release -sc’
main” > /etc/apt/sources.list.d/ros2-latest.list
# setup environment
ENV LANG C.UTF-8
ENV LC_ALL C.UTF-8.
```

TABLE 5

# clone source
ENV ROS2_WS /opt/ros2_ws
RUN mkdir -p $ROS2_WS/src
WORKDIR $ROS2_WS
wget http://raw.githubusercontent.com/ros2/ros2/dashing/ros2.repos
vcs import src < ros2.repos
## LGE Package install
## download using LGE internal repository
wget http://robot.remote.lge.com/lidar_ubuntu_install.sh
source ./lidar_01_install.sh
wget -0 http://robot.remote.lge.com/imu_ubuntu_install.sh
source ./imu_ubuntu_install.sh
wget -0 http://robot.remote.lge.com/camera_ubuntu_install.sh
source ./camera_ubuntu_install.sh

[Table 4] and [Table 5] show a docker file created by a cloud server according to an embodiment of the present disclosure.

[Table 4] and [Table 5] show an example of building a docker file based on OS information, platform information, and sensor information of a robot by acquiring a profile based on the robot capability and using a docker file template created as a default. In addition, according to the present disclosure, a docker file may be built according to a build instruction basically used in Linux as shown below.

In more detail, referring to [Table 4], according to an embodiment of the present disclosure, a robot software converter may retrieve the same OS based on the received OS information of the robot profile. For example, if the OS of the received robot profile is ubuntu:18.04, the robot software converter may build the docker file based on ubuntu:18.04.

Likewise, a time zone may be configured, a package may be installed, and a key, a source, and an environment may be configured with reference to a profile for the robot capability profile in [Table 1], the docker file template in [Table 2], and the profile for the docker file in [Table 3].

Referring to [Table 5], according to an embodiment of the present disclosure, the robot software converter may retrieve related platform information and software information for installing related sensors based on platform information and sensor information of the received robot profile.

In more detail, the robot software converter may record a related platform repository based on the platform information of the received robot profile. For example, when the platform of the received robot profile is ROS2:dashing, the robot software converter may record the platform repository to retrieve ROS2:dashing in the docker file.

Likewise, the robot software converter may record software information for installing a sensor based on the sensor information of the received robot profile. For example, when the received robot profile includes lidar sensor information, inertial measurement device sensor information, and camera sensor information, software information (e.g., url address) for installing these may be recorded.

Through the aforementioned embodiment, information that is not present in the cloud server may be created based on the OS information, hardware information, and software information of the robot to provide a specific function to other robots. In other words, it may be possible to create information that is not present in the cloud server and provide converted data and control commands to other robots with heterogeneous OSs installed.

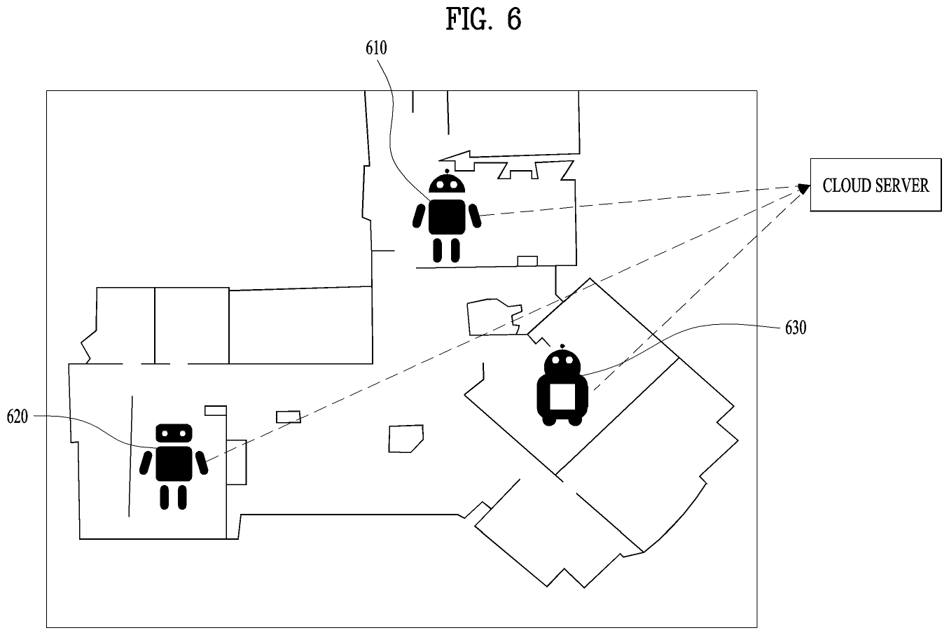

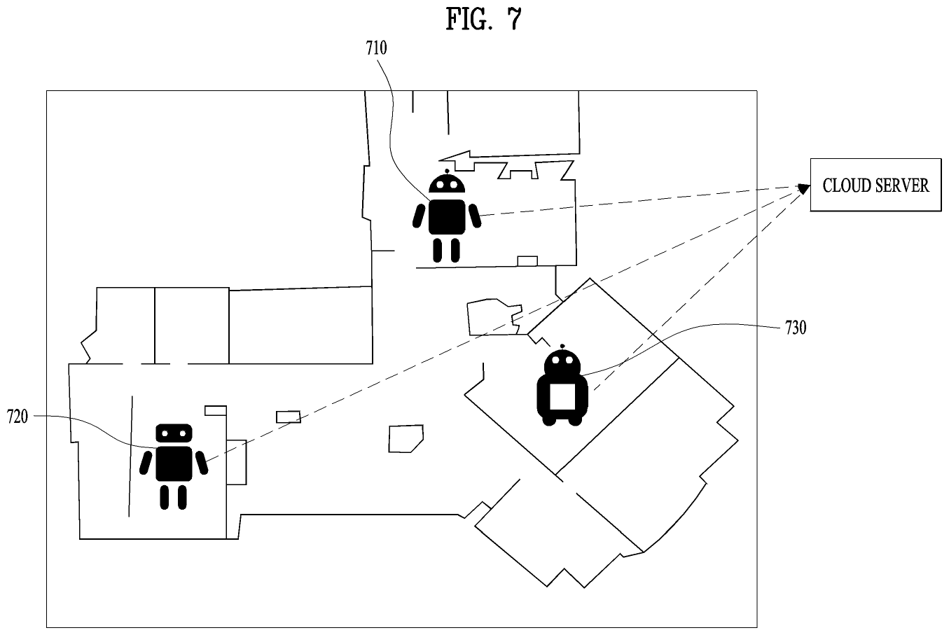

Hereinafter, an embodiment of providing specific functions to different robots will be described. FIG. 6 illustrates an embodiment of work and schedule management of robots with heterogeneous OSs, and FIG. 7 illustrates an embodiment in which, when a first function of a first robot among robots with heterogeneous OSs is updated, the first function of a second robot with a different OS is updated to be the same as the first robot.

FIG. 6 is a diagram for explaining an example in which a cloud server manages work information of a robot, according to an embodiment of the present disclosure.

According to an embodiment of the present disclosure, when the cloud server is connected to a second robot 620 having a different capability from a first robot 610, the cloud server may receive OS information, hardware information, and software information of the second robot 620 and convert the work information of the second robot 620 based on these. The cloud server may transmit the converted work information to the second robot 620. Here, the cloud server may convert work information to assign priorities to robots located on a specific path. For example, while multiple robots move, priorities may be assigned to the robots on a specific path, such as an intersection.

Referring to FIG. 6, the cloud server may manage the OS and hardware of the robot to be optimized for each robot based on works and schedules of a plurality of other robots.

For example, the first robot 610 may use Linux as an OS thereof, and a vendor may be company A. In this case, to manage the work and schedule of the first robot 610, the cloud server may convert the work and schedule information to be suitable for Linux as the OS of the first robot 610 and a robot of company A as the vendor and transmit the converted information to the first robot 610.

Likewise, even if the second robot 610 uses Android as an OS and a vendor thereof is company B, or a third robot 630 uses ROS as an OS and a vendor thereof is company C, the cloud server may convert and transmit work and schedule information based on the OS information, hardware information, and software information of each robot.

Accordingly, even if the OS, hardware, and software of the first robot 610 to the third robot 630 are all different, the cloud server may convert work and schedule information to be suitable for OS information, hardware information, and software information of each robot to separately control the robot.

The cloud server may recognize capabilities of separate robots through the robot profile received from the robot, and thus may know what works and schedules to manage. For example, when a category in the robot profile is classified as “food delivery,” the cloud server may know whether a corresponding robot is a robot that delivers food. As such, the cloud server may command the latest work items and schedules according to the OS and format of the corresponding robot.

FIG. 7 is a diagram for explaining an example in which a cloud server updates a function of a robot, according to an embodiment of the present disclosure.

According to an embodiment of the present disclosure, when the cloud server is connected a third robot 730 having a different capability from a first robot 710, the cloud server may receive OS information, hardware information, and software information of the third robot 730 from a RAP server (or memory).

When updating a first function of the first robot 710, the cloud server may update a first function of the third robot 730 to be the same as that of the first robot 710 based on the OS information, hardware information, and software information of the third robot 730 through the method described above. In this case, the cloud server may convert the first function of the third robot 730 based on the OS, hardware, and software of the third robot 730 through the robot software converter, and then transmit a signal containing information corresponding to the first function to the third robot 730.

In other words, when updating the first function of the first robot 710 among multiple robots, the first function of the different robots 720 and 730 with heterogeneous OS, hardware, and software installed may be updated to be the same as that of the first robot 710.

According to an embodiment of the present disclosure, a process in which, when the first robot 710 updates a first function, a cloud server updates a first function of the third robot 730 in the same way, will be described. According to an embodiment of the present disclosure, the cloud server may search, convert, and create the first function of the third robot 730 based on a profile RAProfile of the corresponding robot and remotely install the first function.

In more detail, the cloud server may search the first function of the third robot 730 inside the cloud server. In this case, when the first function for the third robot 730 is present in the cloud server, the first function may be installed in the third robot 730.

There may be a case in which the first function for the third robot 730 is present in the cloud server, but needs to be converted due to mismatch of specification. For example, the first function for the third robot 730 is present, but needs to be converted due to mismatch of sensor information or content information. In this case, the cloud server may create a software image for the first function based on the robot profile for the third robot 730 and install the software image remotely.

Likewise, there may be a case in which a first function for the third robot 730 in the cloud server, but a new image needs to be created due to version mismatch, and the like. In this case, the cloud server may create a software image for the first function with an updated version based on the robot profile for the third robot 730 and remotely install the software image.

Lastly, the first function for the third robot 730 may not be present in the cloud server. In this case, the cloud server may create a software image for the first function based on the robot profile for the third robot 730 and install the software image remotely.

The aforementioned present disclosure can also be embodied as computer readable code stored on a computer readable recording medium. The computer readable recording medium is any data storage device that can store data which can thereafter be read by a computer. Examples of the computer readable recording medium include a hard disk drive (HDD), a solid state drive (SSD), a silicon disk drive (SDD), read-only memory (ROM), random-access memory (RAM), CD-ROM, magnetic tapes, floppy disks, optical data storage devices, carrier waves (e.g., transmission via the Internet), etc. The computer may also include the computer 180 of the computer. Thus, it is intended that the present disclosure cover the modifications and variations of this present disclosure provided they come within the scope of the appended claims and their equivalents.

### INDUSTRIAL APPLICABILITY

The present disclosure may be repeatedly implemented in a cloud server and conversion of a software image in a robot of the cloud server.

What is claimed is:

1. A cloud server connected to at least one robot, comprising:
a communicator configured to transmit and receive data to and from the at least one robot and an external device; and
a controller,
wherein:
the controller receives a first signal including operating system (OS) information of a first robot, hardware information of the first robot, and software information of the first robot, from the first robot among the at least one robot;
based on presence of a software image related to the first signal, the controller transmits the software image to the first robot;
based on absence of the software image related to the first signal, the controller extracts the OS information of the first robot, the hardware information of the first robot, and the software information of the first robot, from the first signal;
the controller creates a software image based on the extracted OS information of the first robot, the extracted hardware information of the first robot, and the extracted software information of the first robot; and
the controller transmits the created software image to the first robot.

2. The cloud server of claim 1, further comprising:
a memory configured to store information related to the at least one robot,
wherein, based on presence of the software image related to the first signal in the memory, the stored software image is transmitted to the first robot.

3. The cloud server of claim 1, wherein the controller creates a docker file from a docker file template based on the extracted OS information of the first robot, the extracted hardware information of the first robot, and the extracted software information of the first robot, creates a software image based on the created docker file, and transmits the created software image to the first robot.

4. The cloud server of claim 1, wherein:
the controller includes a robot profile register and a robot software converter;
the robot software converter requests a profile of the first robot from the robot profile register; and
the robot profile register transmits the profile to the robot software converter.

5. The cloud server of claim 4, wherein:
the robot software converter creates the software image based on the received profile; and
the created software image is transmitted to the first robot.

6. The cloud server of claim 2, wherein, based on that the software image related to the first signal is present in the memory but does not satisfy a specification condition, the controller converts the software image to be suitable for a specification and transmits the converted software image to the first robot.

7. The cloud server of claim 1, wherein, based on being connected to a second robot having a different capability from the first robot, the controller receives OS information of the second robot, hardware information of the second robot, and software information of the second robot, from the communicator, converts work information of the second robot based on the received OS information of the second robot, the received hardware information, and the received software information of the second robot, and transmits the converted work information to the second robot.

8. The cloud server of claim 7, wherein the controller converts the work information to assign a priority to a robot located on a specific path.

9. The cloud server of claim 1, wherein, based on being connected to a third robot having a different capability from the first robot, the controller receives OS information of the third robot, hardware information of the third robot, and software information of the third robot, from the communicator;
based on updating of a first function of the first robot, the controller updates the first function of the third robot to be a same as the first robot based on the OS information of the third robot, the hardware information of the third robot, and the software information of the third robot; and
the controller transmits a second signal including information related to the first function to the third robot.

10. A method of converting a software image of a robot in a cloud server connected to at least one robot, the method comprising:
receiving a first signal including operating system (OS) information of a first robot, hardware information of the first robot, and software information of the first robot, from the first robot among the at least one robot;
based on presence of a software image related to the first signal, transmitting the software image to the first robot;
based on absence of the software image related to the first signal, extracting the OS information of the first robot, the hardware information of the first robot, and the software information of the first robot, from the first signal;
creating a software image based on the extracted OS information of the first robot, the extracted hardware information of the first robot, and the extracted software information of the first robot; and
transmitting the created software image to the first robot.
